(19) United States
(12) Patent Application Publication
(10) Pub. No.: US 2008/0117284 A1
(43) Pub. Date: May 22, 2008

(54) Multimedia network sound box

(76) Inventor: Hui-Hu Liang, Siu Shul Hsiang (TW)

Correspondence Address: TROXELL LAW OFFICE PLLC, SUITE 1404, 5205 LEESBURG PIKE, FALLS CHURCH, VA, 22041, US

(21) Appl. No.: 11/600,899

(22) Filed: Nov. 17, 2006

(51) Int. Cl. H04N 7/14

(52) U.S. Cl. 348/14.04

(57) ABSTRACT

One multimedia network sound box, which combines network camera, speaker, microphone and sound box shell into one entity and applies one set of audio & video transmission facility to transmit signal to mainframe of PC so as to provide remote audio & video signal transmission of Internet for video conference and chat. Therefore, it is practical and furthermore reduces installation steps and the cost.

### BACKGROUND OF THE INVENTION

1) Field of the Invention

This invention relates to a multimedia network sound box, which combines network camera, speaker, microphone and sound box shell into one entity, so that the sound box shell can transmit audio & video signal to the remote facility of Internet through mainframe of PC and audio & video controller, so, said sound box shell has audio & video signal transmission function, such 3 in 1 structure is practical and economical.

2) Description of the Prior Art

Usually, the common multimedia-visual and communication transmission mode of Internet is based on network camera, PC and monitor to undergo bidirectional transmission of audio & video signal of Internet, and then to have live broadcasting and chat through separate speaker and microphone.

### SUMMARY OF THE INVENTION

### 1. Problems to Solve

(1) Since the common multimedia audio & video transmission is undertaken separately through network camera, speaker and microphone, if held video conference, must install all of them, so, it is inconvenient for user.

(2) Furthermore, the cost is high since you must buy all facilities required, even if speaker and microphone are combined into one entity which can occupy less room, however, the network camera must be installed separately, so, it is still inconvenient.

### 2. Solutions

(1) This invention uses a signal transmission facility to transmit signal of network camera, microphone and speaker assembled in sound box shell to mainframe of PC and audio & video controller and then speaker makes sound through amplifier; in addition, signal of microphone is transmitted into mainframe of PC by signal transmission facility through echo cancellation circuit and audio &video controller, and then Internet server transmits it to the remote visual & communication facility to make sound, meanwhile, signal of network camera is transmitted into mainframe of PC by signal transmission facility and then Internet transmits it to the remote visual & communication facility to hold a real-time visual and communication conference, furthermore, signal of microphone can be also transmitted into audio & video mixer through above said echo cancellation circuit and audio &video controller, so that signal of microphone is transmitted into audio &video controller by signal transmission facility along with the signal from the remote visual & communication facility and transmitted by Internet, thus, basing on audio & video mixer and amplifier, speaker can broadcast a mixed sound from the remote sound and that of microphone, such 3 in 1 structure can further reduce installation time and the cost accordingly.

(2) This invention connects EEPROM to audio & video controller, so that data stored in EEPROM can transmit audio & video signal after obtained when starting audio &video controller.

(3) The signal transmission facilities of this invention include USB, PS2, cables, radio frequency, infrared ray, Bluetooth system and WiFi.

(4) This invention applies a sound box shell to combine network camera, microphone and speaker into one entity and to undertake remote visual and communication transmission through the signal transmission facility.

### BRIEF DESCRIPTION OF THE DRAWINGS

FIG. 1 is the appearance sketch map of this invention

FIG. 2 is the diagram block of signal transmission device of this invention

### DETAILED DESCRIPTION OF THE PREFERRED EMBODIMENTS

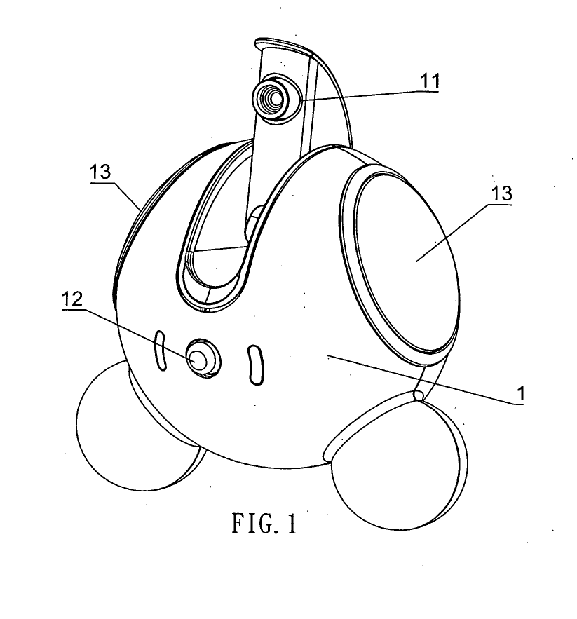

Please refer to FIG. 1, it is comprised by sound box shell 1, network camera 11, microphone 12 and speaker 13, of which sound box shell 1 can be produced into all kinds of shapes as required for better decoration.

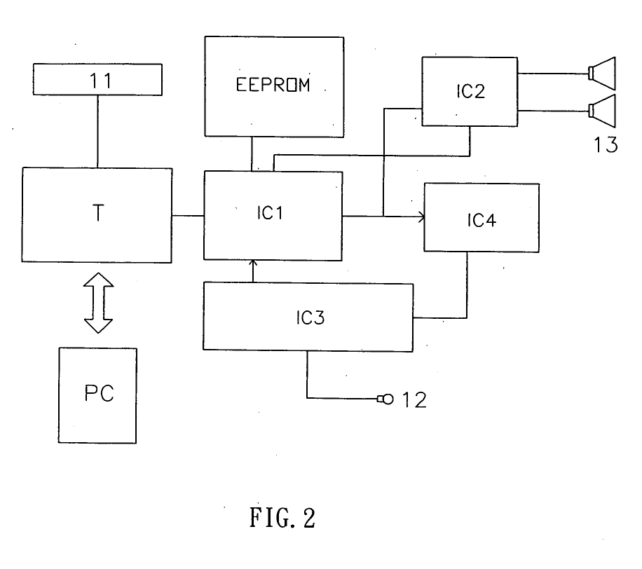

Please refer to FIG. 2, PC and sound box 1 is connected with a set of signal transmission facility T which includes USB, PS2, cables, radio frequency, infrared ray, Bluetooth system and WiFi.

Please refer to FIG. 1 and FIG. 2, sound box shell 1 is connected to input jack of transmission facility T through network camera 11 and audio & video controller IC 1 is connected with signal transmission facility T, which is also respectively connected to EEPROM, audio & video mixer IC4, echo cancellation circuit IC3 and amplifier IC2, wherein echo cancellation circuit IC3 is then connected with microphone 12 and amplifier IC2 is connected to speaker 13.

Please refer to FIG. 1 and FIG. 2, the signal transmission facility T transmits signal of network camera 11, microphone 12 and speaker 13 assembled in sound box shell 1 to mainframe of PC and audio & video controller IC1, and then speaker 13 makes sound through amplifier IC 1; in addition, signal of microphone 12 is transmitted into mainframe of PC by signal transmission facility T through echo cancellation circuit IC3 and audio &video controller IC1, and then Internet server transmits it to the remote visual & communication facility to make sound, meanwhile, signal of network camera 11 is transmitted into mainframe of PC by signal transmission facility T and then Internet transmits it to the remote visual & communication facility to hold a real-time visual and communication conference, furthermore, signal of microphone 12 can be also transmitted into audio & video mixer IC4 through above said echo cancellation circuit IC 3 and audio &video controller IC 1, so that signal of microphone 12 is transmitted into audio &video controller IC1 by signal transmission facility T along with the signal from the remote visual & communication facility and transmitted by Internet, thus, basing on audio & video mixer IC 4 and amplifier IC2, speaker 13 can broadcast a mixed sound from the remote sound and that of microphone 12, such 3 in 1 structure can further reduce installation time and the cost accordingly.

EEPROM is connected to audio & video controller IC 1 so that data stored in EEPROM can transmit audio & video signal after obtained when starting controller IC 1.

What is claimed is:

1. A multimedia network sound box, which is comprised by:
Sound box shell combining network camera, microphone and speaker into one entity;
Network camera connecting to input jack of signal transmission facility;
Circuit devices connect audio & video controller with signal transmission facility, which are respectively connected with EEPROM, audio &video mixer, echo cancellation circuit and amplifier.
Microphone connecting to input jack of echo cancellation circuit;
Speaker connecting to output jack of audio & video amplifier;
Therefore, the signal transmission facility transmits signal of network camera, microphone and speaker assembled in sound box shell to mainframe of PC and audio & video controller and then speaker makes sound through amplifier; in addition, signal of microphone is transmitted into mainframe of PC by signal transmission facility through echo cancellation circuit and audio &video controller, and then Internet server transmits it to the remote visual & communication facility to make sound, meanwhile, signal of network camera is transmitted into mainframe of PC by signal transmission facility and then Internet transmits it to the remote visual & communication facility to hold a real-time visual and communication conference, furthermore, signal of microphone can be also transmitted into audio & video mixer through above said echo cancellation circuit and audio &video controller, so that signal of microphone is transmitted into audio &video controller by signal transmission facility along with the signal from the remote visual & communication facility and transmitted by Internet, thus, basing on audio & video mixer and amplifier, speaker can broadcast a mixed sound from the remote sound and that of microphone, such 3 in 1 structure can further reduce installation time and the cost accordingly.

2. As claimed in claim 1, wherein EEPROM is connected to audio & video controller so that data stored in EEPROM can transmit audio & video signal after obtained data when starting controller.

3. As claimed in claim 1, wherein said signal transmission facility includes USB, PS2, cables, radio frequency, infrared ray, Bluetooth system and WiFi.

4. As claimed in claim 1, wherein the said sound box shell can be produced into all kinds of shapes as required for better decoration.

5. As claimed in claim 1, wherein at lease over one set of speaker cab be assembled in said sound box shell.

6. As claimed in claim 1, wherein at least over one set of microphone can be assembled in said sound box shell.
